(19) United States
(12) Patent Application Publication
(10) Pub. No.: US 2007/0208128 A1
(43) Pub. Date: Sep. 6, 2007

(54) POLYCARBONATE RESIN COMPOSITION WITH IMPROVED LIGHT REFLECTANCE AND FLAME RETARDANCY

(75) Inventors: Hyuk Jin Jung, Uiwang-si, Gyeonggi-do (KR); Jong Cheol Lim, Uiwang-si, Gyeonggi-do (KR); Tae Gon Kang, Uiwang-si, Gyeonggi-do (KR)

Correspondence Address: KNOBBE MARTENS OLSON & BEAR LLP, 2040 MAIN STREET, FOURTEENTH FLOOR, IRVINE, CA, 92614, US

(73) Assignee: CHEIL INDUSTRIES INC., Kumi-si (KR)

(21) Appl. No.: 11/677,009

(22) Filed: Feb. 20, 2007

Related U.S. Application Data
(63) Continuation-in-part of application No. PCT/KR06/02091, filed on May 30, 2006.

(30) Foreign Application Priority Data
May 29, 2006 (KR) 10-2006-0048150
Dec. 30, 2005 (KR) 10-2005-0136093

(51) Int. Cl. C08K 3/22; C08F 290/04

(52) U.S. Cl. 524/497; 524/504; 523/200

(57) ABSTRACT

Disclosed herein is a polycarbonate resin composition with improved light reflectance and flame retardancy. The composition also displays a good balance of physical properties such as workability and appearance.

### CROSS-REFERENCE TO RELATED APPLICATIONS

This application is a continuation-in-part application of International Application No. PCT/KR2006/002091 filed on May 30, 2006, designating the United States, which claims the benefit of Korean Patent Application Nos. 10-2005-0136093 filed Dec. 30, 2005, and 10-2006-0048150 filed on May 29, 2006.

### BACKGROUND

1. Field

The present invention relates to a polycarbonate resin composition, a method of making a polycarbonate resin composition and an article made from a polycarbonate resin composition. In preferred embodiments, the polycarbonate resin composition has improved light reflectance and flame retardancy.

2. Discussion of Related Technology

Generally, polycarbonate resins are plastics exhibiting high mechanical strength, improved heat resistance and transparency. Such resins are used in a wide range of engineering applications, including office automation (OA) equipment, electronics and construction materials. In many cases, these compositions are blended to overcome some of the disadvantages of polycarbonate resins. Such disadvantages include poor processability and low notch impact strength.

Resins used in electronic equipment, such as backlight components for liquid crystal displays (LCDs), require high light reflectance, good flame retardancy, good light resistance and superior color fixation. As electronic products, such as television sets, monitors and notebook computers have become increasingly slim and thin; resins used in these electronic products are also required to have high fluidity. The foregoing discussion in this section is solely to provide background information and does not constitute an admission of prior art.

### SUMMARY

One aspect of the invention relates to a polycarbonate resin composition. According to embodiments, the polycarbonate resin composition can comprise 100 parts by weight of a polycarbonate resin, about 2 to about 40 parts by weight of titanium dioxide, about 0.1 to about 15 parts by weight of an impact modifier comprising a rubber polymer grafted with polymeric side chains, about 0.01 to about 20 parts by weight of a phenyl-substituted siloxane copolymer and about 0.01 to about 10 parts by weight of a fluorinated polyolefin resin.

Another aspect of the invention relates to a method of preparing the foregoing polycarbonate resin composition. According to embodiments, this method comprises providing the components of the polycarbonate resin composition described above and mixing the components.

Another aspect of the invention relates to a molded article made from the polycarbonate resin composition described above. In some embodiments, molded articles made from the polycarbonate resin composition described above can be suitable for use in a variety of electronic products, including backlight components for liquid crystal displays, television sets, monitors and notebook computers.

### DETAILED DESCRIPTION OF EMBODIMENTS

As noted above, one aspect of the invention relates to a polycarbonate resin composition. The polycarbonate resin composition comprises a polycarbonate resin, titanium dioxide, an impact modifier, a phenyl-substituted siloxane copolymer and a fluorinated polyolefin resin. Optionally, the polycarbonate resin can further comprise one or more additives such as UV stabilizers, fluorescent brighteners, antioxidants, heat stabilizers, lubricants, release agents, nucleating agents, stabilizers, reinforcing agents, inorganic additives, pigments and dyes. The relative amounts of the polycarbonate resin composition components can vary. The amounts will be described with reference to 100 parts by weight of a polycarbonate resin. Another aspect of the invention relates to a method of preparing the foregoing polycarbonate resin composition. An additional aspect of the invention relates to a molded article formed from the foregoing polycarbonate resin composition. A molded article formed from the foregoing polycarbonate resin composition can have an average light reflectivity before and after UV irradiation for 24 hours of at least about 85, a yellow index before UV irradiation of less than about 3.0 a flame retardancy of about V-0 or V-1 when evaluated using a 1.6 mm thick specimen measured in accordance with UL-94, a total flame out of less than about 30 sec., an Izod impact strength of at least about when evaluated using ⅛″ specimens measured in accordance with ASTM D256, a melt flow index of between about 20 and about and a Cicat softening point of at least about 135° C. when evaluated in accordance with ASTM D1525. A more detailed description of each of the components of the resin according to various embodiments follows.

Polycarbonate Resin

In various embodiments, the polycarbonate resin can comprise homopolymers or copolymers having functional groups linked together by carbonate groups. Examples of suitable carbonate groups include, but are not limited to, polyaromatic carbonates, polyaliphatic carbonates, and mixtures thereof. The polycarbonate resins can be branched or can be linear.

According to a preferred embodiment, the polycarbonate resin can be prepared by reacting phosgene, a haloformate or a carbonic diester with a diphenol represented by Formula 1 below:

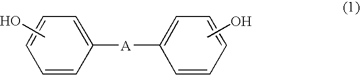

wherein A is a single bond, C₁-C₅ alkylene, C₂-C₅ alkylidene, C₅-C₆ cycloalkylidene, —S—, or —SO₂—.

Examples of suitable diphenols include hydroquinone, resorcinol, 4,4′-dihydroxydiphenol, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro-4-hydroxyphenyl)-propane, and 2,2-bis-(3,5-dichloro-4-hydroxyphenyl)-propane. Of these, 2,2-bis-(4-hydroxyphenyl)-propane, 2,2-bis-(3,5-dichloro-4-hydroxyphenyl)-propane and 1,1-bis-(4-hydroxyphenyl)-cyclohexane are preferred, and 2,2-bis-(4-hydroxyphenyl)-propane called ‘bisphenol A’ is more preferred. The weight average molecular weight of the polycarbonate resin is preferably from 10,000 to 200,000, and is more preferably from 15,000 to 80,000.

According to preferred embodiments, the polycarbonate resin can be prepared by adding 0.05 to 2 mol %, based on the total weight of diphenols used, of tri- or higher functional compounds. Such tri- or higher functional compounds include those having three or more phenolic groups.

The polycarbonate resin may be wholly or partially replaced with an ester precursor. For example, an aromatic polyester-carbonate resin prepared by polymerization of a difunctional carboxylic acid.

Titanium Dioxide

In various embodiments, the titanium dioxide can be present in any form. The titanium dioxide can be present in a rutile, anatase, brookite or titanium dioxide (B) form. In addition, the shape of the titanium dioxide particles is not limited. The particles can be flaky, spherical or amorphous. The titanium dioxide can also be present in a powder state. Finally, the particle size of the titanium dioxide particles is not limited.

In various embodiments, the titanium dioxide can be surface treated. The titanium dioxide can be surface treated with an inorganic surface-treating agent, an organic surface-treating agent or a combination of the two.

Inorganic surface-treating agents include aluminum oxide (alumina, Al2O3), silicon dioxide (silica, SiO2), zirconium dioxide (zirconia, ZrO2), sodium silicate, sodium aluminate, sodium aluminum silicate, zinc oxide or mica. Aluminum oxide is most preferred. The inorganic surface-treating agent is preferably used in an amount equal to 2 parts by weight or less, based on 100 parts by weight of the titanium dioxide.

Organic surface-treating agents include polydimethylsiloxane, trimethylpropane (TMP), and pentaerythritol. The organic surface-treating agent is preferably used in an amount equal to 0.3 parts by weight or less, based on 100 parts by weight of the titanium dioxide.

The surface-treated titanium dioxide may be further modified with an additional inorganic or organic surface-treating agent. The inorganic or organic surface-treating agent used herein may be the same as that used above.

The titanium dioxide can comprise about 1, 3, 5, 10, 15, 20, 25, 30, 33, 35 or 40 parts by weight with reference to 100 parts by weight of the polycarbonate resin. In addition, the titanium dioxide can be present in an amount in a range from about any of the foregoing numbers to about any other of the foregoing numbers.

Impact Modifier

According to embodiments, the impact modifier can comprise a rubber polymer grafted with polymer or copolymer side chains.

According to embodiments, examples of the rubber polymer include acryl rubber, ethylene/propylene rubber, polyorganosiloxane/polyalkyl(meth)acrylate rubber composite or mixtures thereof.

In some embodiments, the rubber polymer comprises about 5, 10, 20, 30, 40, 50, 60, 70, 80, 90, or 95 parts by weight with reference to 100 parts by weight of the impact modifier. In addition, the rubber polymer comprises an amount in a range from about any of the foregoing numbers to any of the other foregoing numbers.

The polymer or copolymer side chains can be grafted onto the rubber polymer by methods known in the art. Various polymerization techniques can be used including emulsion polymerization, bulk polymerization, emulsion-polymerization, bulk polymerization, emulsion-suspension polymerization, emulsion-bulk polymerization, emulsion-solution polymerization and micro-suspension polymerization.

The side chains can comprise polymer or copolymer moieties or chains attached to the rubber particles or cores. The polymer or copolymer side chains can be prepared by polymerizing a monomer mixture. According to embodiments, the polymer or copolymer side chains can be prepared from a monomer mixture comprising about 40 to about 95 parts by weight, with reference to 100 parts by weight of the monomer mixture, of styrene, α-methylstyrene, a halogen- or alkyl-substituted styrene, a C₁-C₈ methacrylic acid alkyl ester, a C₁-C₈ acrylic acid alkyl ester or a mixture thereof, and about 5 to about 60 parts by weight, with reference to 100 parts by weight of the monomer mixture, of acrylonitrile, methacrylonitrile, a C₁-C₈ methacrylic acid alkyl ester, a C₁-C₈ acrylic acid alkyl ester, maleic acid anhydride, C₁-C₄ alkyl or phenyl N-substituted maleimide or a mixture thereof. The C₁-C₈ methacrylic or C₁-C₈ acrylic acid alkyl ester mentioned above can be an ester of methacrylic or acrylic acid. Specific examples thereof can include methacrylic acid methyl ester, methacrylic acid ethyl ester, methacrylic acid propyl ester, and acrylic acid ethyl ester.

In some embodiments, the monomer mixture comprises about 5, 10, 20, 30, 40, 50, 60, 70, 80, 90, or 95 parts by weight with reference to 100 parts by weight of the impact modifier. In addition, the monomer mixture may comprise an amount in a range from about any of the foregoing numbers to any of the other foregoing numbers.

The polymer or copolymer moieties or chains can be prepared via polymerization techniques known in the art including emulsion polymerization, bulk polymerization, emulsion-polymerization, bulk polymerization, emulsion-suspension polymerization, emulsion-bulk polymerization, emulsion-solution polymerization and micro-suspension polymerization.

In some embodiments, the impact modifier comprises about 1, 3, 5, 7, 9, 10 or 12 parts by weight with reference to 100 parts by weight of the polycarbonate resin. In addition, the impact modifier may comprise an amount in a range from about any of the foregoing numbers to about any of the other foregoing numbers.

Phenyl-Substituted Siloxane Copolymer

In various embodiments, the phenyl-substituted siloxane copolymer can comprise a linear, cyclic, network structured or partially branched linear siloxane polymer or copolymer moiety or chain with one or more phenyl or substituted phenyl groups bonded to one or more silicon atoms in the siloxane polymer or copolymer moieties or chains. The substituted phenyl group can comprise mono-substituted phenyl or poly-substituted phenyl. In addition, the phenyl-substituted siloxane copolymer can comprise other groups bonded to one or more silicon atoms in the siloxane polymer or copolymer moieties or chains.

According to preferred embodiments, the mono-substituted phenyl group bonded to one or more silicon atoms in the siloxane polymer or copolymer moiety or chain comprises phenyl substituted with alkyl groups, alkenyl groups, aryl groups, hydroxy groups, aldehyde groups, carbonyl groups and aryl groups. Specific examples include methylphenyl, ethylphenyl, propylphenyl, isopropylphenyl, butylphenyl, pentylphenyl, hexylphenyl, vinylphenyl, allenylphenyl, butenylphenyl, pentenylphenyl, hexenylphenyl, biphenyl, toylylpheny, xylylphenyl, methoxyphenyl, ethoxyphenyl, propoxyphenyl, hydroxyphenyl and homologues thereof.

According to preferred embodiments, the poly-substituted phenyl group bonded to one or more silicon atoms in the siloxane polymer or copolymer moiety chain comprises phenyl substituted with multiple alkyl groups, alkenyl groups, aryl groups, hydroxy groups, aldehyde groups, carbonyl groups, aryl groups and combinations thereof. Specific examples include polymethylphenyl, polyethylphenyl, polypropylphenyl, polyisopropylphenyl, polybutylphenyl, polypentylphenyl, polyhexylphenyl, polymethoxyphenyl, polyethoxyphenyl polypropoxyphenyl, polyhydroxyphenyl and homologues and combinations thereof.

According to certain embodiments, the other groups bonded to one or more silicon atoms in the siloxane polymer or copolymer moiety or chain comprise alkyl groups, alkenyl groups, aryl groups, hydroxy groups, aldehyde groups, carbonyl groups and aryl groups. Specific examples include methyl, ethyl, propyl, isopropyl, butyl, pentyl, hexyl, vinyl, allenyl, butenylphenyl, pentenyl, hexenyl, phenyl, toylyl, xylyl, methoxy, ethoxy, propoxy, hydroxy and homologues thereof.

In some embodiments, the phenyl-substituted siloxane copolymer can be represented by Formula 2 below:

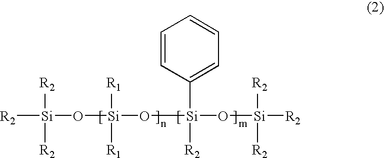

wherein R₁ represents a methyl, ethyl, propyl, isopropyl, butyl, pentyl, hexyl, vinyl, allenyl, butenyl, pentenyl, hexenyl, phenyl, toylyl, xylyl, methoxy, ethoxy, propoxy, or hydroxy group or homologues thereof, R₂ represents a methyl, ethyl, propyl, isopropyl, butyl, pentyl, hexyl, vinyl, allenyl, butenylphenyl, pentenyl, hexenyl, phenyl, toylyl, xylyl, methoxy, ethoxy, propoxy or hydroxy group or homologues thereof, the ratio n:m is from 40:1 to 1:40, and the sum of n and m is an integer from 1 to 1000. According to preferred embodiments, the ration:mls from 9:1 to 3:7.

Examples of phenyl-substituted siloxane copolymers include, but are not limited to, poly[methyl(phenyl)]siloxane, poly[ethyl(phenyl)]siloxane, poly[propyl(phenyl)]siloxane, poly[butyl(phenyl)]siloxane, poly[pentyl(phenyl)]siloxane, poly[vinyl(phenyl)]siloxane, poly[allenyl(phenyl)]siloxane, poly[butenyl(phenyl)]siloxane poly[pentenyl(phenyl)]siloxane, poly[diphenyl]siloxane, poly[methoxy(phenyl)]siloxane, poly[ethoxy(phenyl)]siloxane, poly[propoxy(phenyl)] siloxane, poly[isopropoxy(phenyl)]siloxane, poly[hydroxy(phenyl)]siloxane, poly[diphenyl]siloxane, poly[methyl(methylphenyl)]siloxane, poly[ethyl(methylphenyl)]siloxane, poly[propyl(ethylphenyl)]siloxane, poly[butyl(methylphenyl)]siloxane, poly[pentyl(ethylphenyl)]siloxane, poly[vinyl(hydroxyphenyl)]siloxane, poly[allenyl(methylphenyl)]siloxane, poly[butenyl(hydroxyphenyl)]siloxane poly[pentenyl(methoxyphenyl)]siloxane, poly[phenyl(ethoxyphenyl)]siloxane, poly[methoxy(methylphenyl)]siloxane, poly[ethoxy(methoxyphenyl)]siloxane, poly[propoxy(vinylphenyl)]siloxane, poly[isopropoxy(allenylphenyl)]siloxane, poly[hydroxy(hydroxyphenyl)]siloxane, poly[dimethyl]siloxane-poly[methyl(phenyl)]siloxane copolymers, poly[dimethyl]siloxane-poly[ethyl(phenyl)]siloxane copolymers, poly[dimethyl]siloxane-poly[propyl(phenyl)]siloxane copolymers, poly[dimethyl]siloxane-poly[butyl(phenyl)]siloxane copolymers, poly[methyl(phenyl)]siloxane-poly[pentyl(phenyl)]siloxane copolymers, poly[methyl(phenyl)]siloxane-poly[vinyl(phenyl)]siloxane copolymers, poly[methyl(phenyl)]siloxane-poly[allenyl(phenyl)]siloxane copolymers, poly[methyl(hydroxy)]siloxane-poly[butenyl(phenyl)]siloxane copolymers, poly[methyl(hydroxy)]siloxane-poly[pentenyl(phenyl)]siloxane copolymers, poly[methyl(hydroxy)]siloxane-poly[diphenyl]siloxane copolymers, poly[dimethyl]siloxane-poly[methoxy(phenyl)]siloxane copolymers, poly[ethyl(hydroxy)]siloxane-poly[ethoxy(phenyl)]siloxane copolymers, poly[ethyl(hydroxy)]siloxane-poly[propoxy(phenyl)]siloxane copolymers, poly[diethyl]siloxane-poly[isopropoxy(phenyl)]siloxane copolymers, poly[ethyl(methoxy)]siloxane-poly[hydroxy(phenyl)]siloxane copolymers, poly[dimethoxy]siloxane-poly[diphenyl]siloxane copolymers, and homologues and combinations thereof.

The polymer or copolymer moieties or chains can be prepared via polymerization techniques known in the art including, but not limited to, emulsion polymerization, bulk polymerization, emulsion-polymerization, bulk polymerization, emulsion-suspension polymerization, emulsion-bulk polymerization, emulsion-solution polymerization and micro-suspension polymerization.

The number of phenyl-substituted siloxane repeating units preferably makes up at least about 1%, 5%, 10%, 15%, 20%, 25%, 30% or 35% of the overall repeating units of the phenyl-substituted siloxane polymer or copolymer.

According to certain embodiments, the viscosity of the phenyl-substituted siloxane copolymer at 25° C. is preferably about 1, 100, 200, 300, 400, 500, 600, 700, 800, 900 or 1,000 centistokes (cSt). In addition, the viscosity can be in a range from about any of the foregoing amounts to any of the other foregoing amounts.

In some embodiments, the phenyl-substituted siloxane copolymer can comprise about 0.01, 0.05, 0.1, 0.5, 1, 3, 5, 7, 9, 10, 12, 15, 18 or 20 parts by weight with reference to 100 parts by weight of the polycarbonate resin. In addition, the phenyl-substituted siloxane copolymer can comprise an amount in a range from about any of the foregoing numbers to about any of the other foregoing numbers.

Fluorinated Polyolefin Resin

In various embodiments, the fluorinated polyolefin resin can comprise branched or linear polyalkene polymer or copolymer moieties or chains with one or more substituted fluorine groups. According to certain embodiments, the fluorine group is bonded to the molecules in the polymer or copolymer moiety or chain, or, alternatively, it is bonded to the molecules in any branches present in the polymer or copolymer moiety or chain.

According to some embodiments, the fluorinated polyolefin resin may be used in an emulsive or powder state. In addition, according to embodiments, the fluorinated polyolefin resin may have an average particle size in a range from between about 0.05 and about 1,000 μm and a density in a range from between about 1.2 and about 2.3 g/cm³.

The fluorinated polyolefin resin can be prepared via polymerization techniques known in the art including, but not limited to, emulsion polymerization, bulk polymerization, emulsion-polymerization, bulk polymerization, emulsion-suspension polymerization, emulsion-bulk polymerization, emulsion-solution polymerization and micro-suspension polymerization. According to embodiments, the fluorinated polyolefin resin can be prepared in an aqueous medium under a pressure of between about 7 and about 71 kg/cm² at a temperature of between about 0 and about 200° C., in the presence of a free radical-forming catalyst such as sodium, potassium or ammonium peroxydisulfate.

Examples of fluorinated polyolefin resins include, but are not limited to, polytetrafluoroethylene, polyvinylidenefluoride, tetrafluoroethylene/vinylidenefluoride copolymers, tetrafluoroethylene/hexafluoropropylene copolymers, and ethylene/tetrafluoroethylene copolymers. These resins may be used individually or in combinations.

In some embodiments, the fluorinated polyolefin resin comprises about 0.01, 0.05, 0.1, 0.5, 1, 2, 3, 4, 5 or 7 parts by weight with reference to 100 parts by weight of the polycarbonate resin. In addition, the fluorinated polyolefin resin can comprise an amount in a range from about any of the foregoing amounts to about any of the other foregoing amounts.

Additives

As described above, according to some embodiments, the polycarbonate resin composition further comprises one or more additives such as UV stabilizers, fluorescent brighteners, antioxidants, heat stabilizers, lubricants, release agents, nucleating agents, antistatic agents, stabilizers, reinforcing agents, inorganic additives, pigments and dyes.

Possible examples of UV stabilizers include benzotriazole, benzophenone or triazine compounds represented by Formulae 3, 4 and 5, respectively:

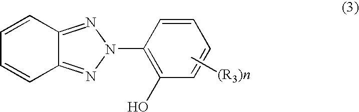

wherein R₃ is a C₁-C₁₀ alkyl or C₅-C₁₅ alkyl-substituted phenyl group, and n is an integer from 1 or 2;

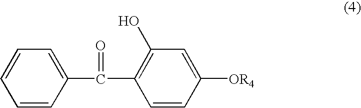

wherein R₄ is a hydrogen atom, a methyl group or a C₅-C₁₅ alkyl-substituted phenyl group; and

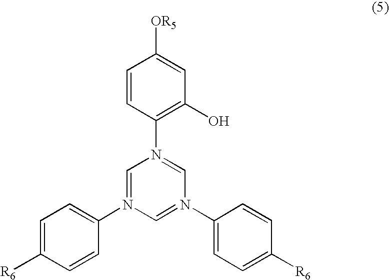

wherein R₅ is a hydrogen atom, a C₁-C₁₈ alkyl group, a C₂-C₆ haloalkyl group, a C₁-C₁₂ alkoxy group or a benzyl group, and each R6 is a hydrogen atom or a methyl group.

Possible examples of fluorescent brighteners include, but are not limited to, stilbene-bisbenzoxazole derivatives. These derivatives generally act to improve the light reflectivity of the polycarbonate resin composition.

Specific examples of such stilbene-bisbenzoxazole derivatives include, but are not limited to, 4-(benzoxazol-2-yl)-4′-(5-methylbenzoxazol-2-yl)stilbene and 4,4′-bis(benzoxazol-2-yl)stilbene.

In some embodiments, the optional additives can comprise about 0.01, 0.05, 0.1, 0.5, 1, 3, 5, 7, 9 or 10 parts by weight with reference to 100 parts by weight of the polycarbonate resin composition. In addition, the optional additives can comprise an amount in a range from about any of the foregoing amounts to about any of the other foregoing amounts.

Polycarbonate Resin Composition

As described above, according to preferred embodiments, the polycarbonate resin composition comprises polycarbonate resin, titanium dioxide, an impact modifier, a phenyl-substituted siloxane copolymer, a fluorinated polyolefin resin, and, optionally, one or more additives. In addition, as described above, the components of the polycarbonate resin composition can be present in various amounts.

Examples of the polycarbonate resin composition include, but are not limited to, the following descriptions:

A polycarbonate resin composition comprising 100 parts by weight of a polycarbonate resin, 10 parts by weight of titanium dioxide, 10 parts by weight of an impact modifier, 1 part by weight poly[methyl(phenyl)]siloxane and 1 part by weight of a fluorinated polyolefin resin.

A polycarbonate resin composition comprising 100 parts by weight of a polycarbonate resin, 20 parts by weight of titanium dioxide, 5 parts by weight of an impact modifier, 0.1 part by weight of poly[butyl(phenyl)]siloxane and 5 parts by weight of a fluorinated polyolefin resin.

A polycarbonate resin composition comprising 100 parts by weight of a polycarbonate resin, 30 parts by weight of titanium dioxide, 10 parts by weight of an impact modifier, 5 parts by weight of poly[pentyl(phenyl)]siloxane and 5 parts by weight of a fluorinated polyolefin resin.

A polycarbonate resin composition comprising 100 parts by weight of a polycarbonate resin, 20 parts by weight of titanium dioxide, 5 parts by weight of an impact modifier, 10 parts by weight of poly[vinyl(phenyl)]siloxane and 5 parts by weight of a fluorinated polyolefin resin.

A polycarbonate resin composition comprising 100 parts by weight of a polycarbonate resin, 20 parts by weight of titanium dioxide, 10 parts by weight of an impact modifier, 10 parts by weight of poly[allenyl(phenyl)]siloxane and 1 part by weight of a fluorinated polyolefin resin.

A polycarbonate resin composition comprising 100 parts by weight of a polycarbonate resin, 40 parts by weight of titanium dioxide, 10 parts by weight of an impact modifier, 15 parts by weight of poly[butenyl(phenyl)]siloxane, 1 part by weight of a fluorinated polyolefin resin, and 1 part by weight of a UV stabilizer.

A polycarbonate resin composition comprising 100 parts by weight of a polycarbonate resin, 40 parts by weight of titanium dioxide, 10 parts by weight of an impact modifier, 20 parts by weight of poly[pentenyl(phenyl)]siloxane, 1 part by weight of a fluorinated polyolefin resin, and 1 part by weight of a fluorescent brightener.

A polycarbonate resin composition comprising 100 parts by weight of a polycarbonate resin, 10 parts by weight of titanium dioxide, 5 parts by weight of an impact modifier, 10 parts by weight of poly[methoxy(phenyl)]siloxane, and 5 parts by weight of a fluorinated polyolefin resin.

A polycarbonate resin composition comprising 100 parts by weight of a polycarbonate resin, 20 parts by weight of titanium dioxide, 5 parts by weight of an impact modifier, 15 parts by weight of poly[ethoxy(phenyl)]siloxane, and 5 parts by weight of a fluorinated polyolefin resin.

A polycarbonate resin composition comprising 100 parts by weight of a polycarbonate resin, 20 parts by weight of titanium dioxide, 5 parts by weight of an impact modifier, 15 parts by weight of poly[hydroxy(hydroxyphenyl)]siloxane, and 5 parts by weight of a fluorinated polyolefin resin.

A polycarbonate resin composition comprising 100 parts by weight of a polycarbonate resin, 20 parts by weight of titanium dioxide, 5 parts by weight of an impact modifier, 15 parts by weight of poly[dimethyl]siloxane-poly[methyl(phenyl)]siloxane copolymer and 5 parts by weight of a fluorinated polyolefin resin.

A polycarbonate resin composition comprising 100 parts by weight of a polycarbonate resin, 20 parts by weight of titanium dioxide, 5 parts by weight of an impact modifier, 15 parts by weight of poly[dimethyl]siloxane-poly[ethyl(phenyl)]siloxane copolymer and 5 parts by weight of a fluorinated polyolefin resin.

A polycarbonate resin composition comprising 100 parts by weight of a polycarbonate resin, 20 parts by weight of titanium dioxide, 5 parts by weight of an impact modifier, 15 parts by weight of poly[dimethyl]siloxane-poly[ethyl(phenyl)]siloxane copolymer, 5 parts by weight of a fluorinated polyolefin resin and 0.01 part by weight of a pigment.

A polycarbonate resin composition comprising 100 parts by weight of a polycarbonate resin, 20 parts by weight of titanium dioxide, 5 parts by weight of an impact modifier, 15 parts by weight of poly[dimethyl]siloxane-poly[propyl(phenyl)]siloxane copolymer and 5 parts by weight of a fluorinated polyolefin resin.

A polycarbonate resin composition comprising 100 parts by weight of a polycarbonate resin, 20 parts by weight of titanium dioxide, 5 parts by weight of an impact modifier, 0.01 parts by weight of poly[dimethyl]siloxane-poly[butyl(phenyl)]siloxane copolymer and 5 parts by weight of a fluorinated polyolefin resin.

A polycarbonate resin composition comprising 100 parts by weight of a polycarbonate resin, 20 parts by weight of titanium dioxide, 5 parts by weight of an impact modifier, 5 parts by weight of poly[methyl(phenyl)]siloxane-poly[pentyl(phenyl)]siloxane copolymer and 5 parts by weight of a fluorinated polyolefin resin.

Note that the foregoing description is intended merely for illustrative purposes and is not intended to limit the scope of the invention in any manner.

Preparing the Polycarbonate Resin Composition

Preferred methods for preparing the polycarbonate resin composition include providing a polycarbonate resin; providing titanium dioxide; providing an impact modifier; providing a phenyl-substituted siloxane copolymer; providing a fluorinated polyolefin resin; and mixing the polycarbonate resin, the titanium dioxide, the impact modifier, the phenyl-substituted siloxane copolymer and the fluorinated polyolefin resin. The method may further comprise other steps, such as providing one or more additives such as UV stabilizers, fluorescent brighteners, antioxidants, heat stabilizers, lubricants, release agents, nucleating agents, antistatic agents, stabilizers, reinforcing agents, inorganic additives, pigments and dyes, extruding the resin composition, and/or molding the resin composition into a shape.

According to some embodiments, the above components are mixed together all at once. Alternatively, one or more of the components can be added individually or in other combinations.

Formulating and mixing the components can be accomplished by any method known to persons having ordinary skill in the art. The mixing may occur in a pre-mixing state in a device such as a ribbon blender, followed by further mixing in a Henshel mixer, Banbury mixer, a single screw extruder, a twin screw extruder, a multi screw extruder, or a cokneader.

Articles Made From the Polycarbonate Resin Composition

The polycarbonate resin composition may be used to produce articles, including molded articles. The resin composition can be extruded or molded using various molds such as a mold box or a melt-molding device. Further, in some embodiments, the polycarbonate resin composition can be formed into pellets. According to some embodiments, the pellets can then be molded into various shapes using, for example, injection molding, injection compression molding, extrusion molding, blow molding, pressing, vacuum forming or foaming. In some embodiments, the resin composition can be made into pellets using a melt-kneader.

In some embodiments, molded articles can be suitable for use in a variety of electronic products, including backlight components for liquid crystal displays, television sets, monitors and notebook computers.

In some embodiments, at least a portion of a molded article formed from the foregoing polycarbonate resin composition preferably has an average light reflectivity before UV irradiation of at least about 90, 91 or 92. At least a portion of the molded article formed from the foregoing polycarbonate resin composition preferably has an average light reflectivity after UV irradiation for 24 hours of at least about 85, 86, 87, 88, 89, 90, or 91.

In some embodiments, at least a portion of a molded article formed from the foregoing polycarbonate resin composition may have a yellow index of less than about 2.5, 2.6, 2.8 or 3. At least a portion of the molded article formed from the foregoing polycarbonate resin composition preferably has a yellow index after UV irradiation for 24 hours of less than about 7.4, 7.6, 8 or 8.5.

In some embodiments, at least a portion of a molded article formed from the foregoing polycarbonate resin composition can have a flame retardancy of about V-0 or V-1 when evaluated using a 1.6 mm thick specimen measured in accordance with UL-94.

In some embodiments, at least a portion of a molded article formed from the foregoing polycarbonate resin composition preferably has a total flame out of less than about 26, 28, 30 or 32 sec.

In some embodiments, at least a portion of a molded article formed from the foregoing polycarbonate resin composition preferably has an Izod impact strength of at least about 60, 62, 64, 66 or 68 when evaluated using ⅛″ specimens measured in accordance with ASTM D256.

In some embodiments, at least a portion of a molded article formed from the foregoing polycarbonate resin composition preferably has a melt flow index of about 25, 30, 35, 40, 45, 50, 55, 60, 65 or an amount in a range from about any of the foregoing numbers to any of the other foregoing numbers. In addition, at least a portion of a molded article formed from the foregoing polycarbonate resin composition preferably has a Cicat softening point of at least about 135, 137 or 140° C. when evaluated in accordance with ASTM D1525.

The invention may be better understood by reference to the following examples which are intended for illustrative purposes only and are not meant to limit the scope of the present invention as defined by the claims.

### EXAMPLES

The preparation of polycarbonate resin, titanium dioxide, impact modifiers, flame retardants and fluorinated polyolefin resin used in the examples are as follows:

Polycarbonate Resin

A bisphenol-A type polycarbonate resin (PANLITE L-1250W, Teijin, Japan) having a weight average molecular weight of 25,000 g/mol.

Titanium Dioxide

A product marketed under the trademark TI-PURE R-106 by DuPont, U.S.A.

Impact Modifiers:

(IM 1):Copolymer prepared by graft polymerizing a rubber mixture of polybutylacrylate and polydimethylsiloxane with a methacrylic acid methyl ester monomer Metablen S2001, MRC, Japan.

(IM 2): Copolymer prepared by graft polymerizing a methacrylic acid methyl ester monomer with a polybutylacrylate rubber EM-100, LG Chemicals, Korea.

(3): Copolymer prepared by graft polymerizing a polybutadiene rubber with a methacrylic acid methyl ester monomer Paraloid EXL-2602, Rohm & Haas, U.S.A.

Phenyl-Substituted Siloxane Copolymers

(PSSC 1): Polymethylphenylsiloxane oil TSF-433, GE-Toshiba Silicones.

(PSSC 2): Bisphenol-A derived oligomeric phosphoric acid ester CR-741, Daihachi, Japan.

(PSSC 3): Resorcinol derived oligomeric phosphoric acid ester PX-200, Daihachi, Japan.

(PSSC 4): Metal sulfonate salt flame retardant FR-2025, 3M, U.S.A.

Fluorinated Polyolefin Resin

A polyolefin resin Teflon 7AJ, DuPont, U.S.A.

### Examples 1 to 3

After the components were added in accordance with the quantities specified in Table 1, a primary antioxidant (Irganox 1076, Ciba) in the amount of 0.3 parts by weight and a secondary antioxidant (Doverphos S9228PC, Dover Chemical) in the amount of 0.3 parts by weight were added thereto. Each of the mixtures was mixed in a general mixer, extruded through a twin-screw extruder at 180-250° C. with L/D=35 and Φ=45 mm, and pelletized. The pellets were molded into test specimens using a 10 oz injection molding machine at a mold temperature of 280-300° C. The test specimens were subjected to physical property measurements and an evaluation of flame retardancy. The test specimens were allowed to stand at 23° C., RH 50% for 48 hours. The physical properties of the test specimens were measured in accordance with ASTM specifications.

### Comparative Examples 1 to 3

Test specimens were produced in the same manner as outlined in Example 1 with the exception that (PSSC 2), (PSSC 3) and (PSSC 4) were used as flame retardants instead of (PSSC 1) in Comparative Examples 1-3, respectively. The physical properties of the test specimens were evaluated and the results are listed in Table 1.

### Comparative Example 4

Test specimens were produced in the same manner as outlined in Example 1 with the exception that (IM 3) was used as an impact modifier instead of (IM 1). The physical properties of the test specimens were evaluated and the results are listed in Table 1.

### Comparative Examples 5 and 6

Test specimens were produced in the same manner as in Example 1 with the exception that titanium dioxide in the amount of 3 parts by weight and 35 parts by weight were used in Examples 5 and 6, respectively. The physical properties of the test specimens were evaluated, and the results are listed in Table 1.

Table 1 shows the compositions and physical properties of the resins prepared according to Examples 1-3 and Comparative Examples 1-6.

TABLE 1

| | | Example No. | | | Comparative Example No. | | | | | |
|---|---|---|---|---|---|---|---|---|---|---|
| | | 1 | 2 | 3 | 1 | 2 | 3 | 4 | 5 | 6 |
| Polycarbonate resin | | 100 | 100 | 100 | 100 | 100 | 100 | 100 | 100 | 100 |
| Titanium dioxide | | 10 | 20 | 25 | 20 | 20 | 20 | 20 | 3 | 35 |
| Impact modifiers | (IM 1) | 3 | 3 | — | 3 | 3 | 3 | — | 3 | 3 |
| | (IM 2) | — | — | 3 | — | — | — | — | — | — |
| | (IM 3) | — | — | — | — | — | — | 3 | — | — |
| Phenyl-Substituted | (PSSC 1) | 1 | 1 | 1 | — | — | — | 1 | 1 | 1 |
| Siloxane | (PSSC 2) | — | — | — | 7 | — | — | — | — | — |
| Copolymer | (PSSC 3) | — | — | — | — | 5 | — | — | — | — |
| | (PSSC 4) | — | — | — | — | — | 0.1 | — | — | — |
| Fluorinated polyolefin resin | | 0.5 | 0.5 | 0.5 | 0.5 | 0.5 | 0.5 | 0.5 | 0.5 | 0.5 |
| Average light | Before UV | 94 | 94 | 95 | 93 | 93 | 94 | 92 | 57 | 95 |
| Reflectivity | irradiation | | | | | | | | | |
| (300˜700 mm) | After UV | 91 | 92 | 92 | 83 | 85 | 87 | 84 | 45 | 92 |
| | irradiation for | | | | | | | | | |
| | 24 hours | | | | | | | | | |
| Yellow index | Before UV | 2.5 | 2.3 | 2.0 | 3.4 | 3.3 | 2.8 | 3.1 | 5.9 | 2.0 |
| | irradiation | | | | | | | | | |
| | After UV | 7.4 | 5.9 | 5.4 | 14.3 | 13.7 | 11.4 | 12.9 | 18.7 | 5.1 |
| | irradiation for | | | | | | | | | |
| | 24 hours | | | | | | | | | |

| | | | | | | | | | |
|---|---|---|---|---|---|---|---|---|---|
| UL 94 flame retardancy (1.6 mm) | V-0 | V-0 | V-0 | V-1 | V-1 | V-2 | V-0 | V-0 | V-0 |
| | | | | | | (drip) | | | |
| Total flame-out time (sec.) | 21 | 25 | 26 | 73 | 64 | — | 27 | 23 | 32 |
| IZOD impact strength (⅛″) | 71 | 69 | 68 | 47 | 52 | 65 | 61 | 72 | 35 |
| Melt flow index | 31 | 32 | 33 | 58 | 53 | 32 | 30 | 28 | 39 |
| Vicat softening point (° C.) | 140 | 141 | 140 | 124 | 126 | 139 | 139 | 141 | 140 |

Evaluation of Physical Properties

The average light reflectivity and yellow index were measured before and after UV irradiation using a calorimeter marketed under the mark Minolta 3600D by CIE Lab. The specimens were irradiated using a UV-condensation machine in accordance with ASTM G53.

The flame retardancy and total flame-out time were evaluated using 1.6 mm thick specimens in accordance with UL-94.

The total flame-out time was evaluated as the sum of the first flame-out time, the second flame-out time and the glowing time.

The notch Izod impact strength was measured using ⅛″ specimens in accordance with ASTM D256.

The melt flow index was evaluated in accordance with ASTM D1238.

The Vicat softening point was evaluated in accordance with ASTM D1525.

As can be seen from the results of Table 1, the resins prepared in Comparative Examples 1 and 2 showed a large decrease in light reflectance, a very serious change in color after 24 hours of UV irradiation, a lowering in flame retardancy and a considerable decrease in impact strength when compared to those prepared in Examples 1 to 3. Although the resin prepared in Comparative Example 3 showed good impact strength, it also showed a very serious change in color and a decrease in flame retardancy. Conversely, although the resins prepared according to Comparative Examples 4 and 5 showed good flame retardancy and impact strength, they also showed a decrease in light reflectance and yellow index after UV irradiation. Particularly, the resin prepared in Comparative Example 5 showed a very low light reflectivity even before UV irradiation and the largest decrease in yellow index. Although the resin prepared in Comparative Example 6 showed a slight decrease in light reflectivity and yellow index and good flame retardancy, it also displayed the lowest Izod impact strength.

In contrast, the resins prepared according to Examples 1-3 showed only a slight change in color, high impact strength and good flame retardancy while maintaining high light reflectance after UV irradiation.

Those skilled in the art will readily recognize and appreciate that many modifications and variations can be made without departing from the scope and spirit of the invention. Such modifications and variations are encompassed within the scope and spirit of the present invention.

What is claimed is:

1. A polycarbonate resin composition, comprising:
100 parts by weight of a polycarbonate resin;
about 2 to about 40 parts by weight of titanium dioxide;
about 0.1 to about 15 parts by weight of an impact modifier comprising a rubber polymer grafted with polymeric side chains;
about 0.01 to about 20 parts by weight of a phenyl-substituted siloxane copolymer; and
about 0.01 to about 10 parts by weight of a fluorinated polyolefin resin.

2. The polycarbonate resin composition according to claim 1, wherein the titanium dioxide is surface-treated with at least one agent selected from the group consisting of inorganic and organic surface-treating agents.

3. The polycarbonate resin composition according to claim 2, wherein the surface-treated titanium dioxide is further treated with an inorganic or organic surface-treating agent.

4. The polycarbonate resin composition according to claim 1, wherein the rubber polymer comprises about 5 to about 95 parts by weight with reference to 100 parts by weight of the impact modifier and the polymeric side chains comprise about 5 to about 95 parts by weight with reference to 100 parts by weight of impact modifier.

5. The polycarbonate resin composition of claim 1, wherein the rubber polymer is grafted with one or more monomers selected from the group of monomers consisting of styrene, α-methylstyrene, a halogen-substituted styrene, an alkyl-substituted styrene, a C₁-C₈ methacrylic acid alkyl ester, and a C₁-C₈ acrylic acid alkyl ester.

6. The polycarbonate resin composition according to claim 5, wherein the C₁-C₈ methacrylic acid alkyl ester is selected from the group consisting of methacrylic acid methyl ester, methacrylic acid ethyl ester and methacrylic acid propyl ester, and the C₁-C₈ acrylic acid alkyl ester is acrylic acid ethyl ester.

7. The polycarbonate resin composition of claim 5, wherein the rubber polymer is further grafted with at least one monomer selected from the group of monomers consisting of acrylonitrile, methacrylonitrile, maleic acid anhydride, a C₁-C₄ alkyl, phenyl N-substituted maleimide, and a mixture thereof.

8. The polycarbonate resin composition according to claim 1, wherein the rubber polymer is selected from the group consisting of acryl rubbers, ethylene/propylene rubbers, polyorganosiloxane/polyalkyl(meth)acrylate rubber composites, and mixtures thereof.

9. The polycarbonate resin composition according to claim 1, wherein the phenyl-substituted siloxane copolymer is selected from the group consisting of poly[methyl(phenyl)]siloxane, poly[ethyl(phenyl)]siloxane, poly[propyl(phenyl)]siloxane, poly[butyl(phenyl)]siloxane, poly[pentyl(phenyl)]siloxane, poly[vinyl(phenyl)]siloxane, poly[allenyl(phenyl)]siloxane, poly[butenyl(phenyl)]siloxane poly[pentenyl(phenyl)]siloxane, poly[diphenyl]siloxane, poly[methoxy(phenyl)]siloxane, poly[ethoxy(phenyl)]siloxane, poly[propoxy(phenyl)]siloxane, poly[isopropoxy(phenyl)]siloxane, poly[hydroxy(phenyl)]siloxane, poly[diphenyl]siloxane, poly[methyl(methylphenyl)]siloxane, poly[ethyl(methylphenyl)]siloxane, poly[propyl(ethylphenyl)]siloxane, poly[butyl(methylphenyl)]siloxane, poly[pentyl(ethylphenyl)]siloxane, poly[vinyl(hydroxyphenyl)]siloxane, poly[allenyl(methylphenyl)]siloxane, poly[butenyl(hydroxyphenyl)]siloxane poly[pentenyl(methoxyphenyl)]siloxane, poly[phenyl(ethoxyphenyl)]siloxane, poly[methoxy(methylphenyl)]siloxane, poly[ethoxy(methoxyphenyl)]siloxane, poly[propoxy(vinylphenyl)]siloxane, poly[isopropoxy(allenylphenyl)]siloxane, poly[hydroxy(hydroxyphenyl)]siloxane, poly[dimethyl]siloxane-poly[methyl(phenyl)]siloxane copolymers, poly[dimethyl]siloxane-poly[ethyl(phenyl)]siloxane copolymers, poly[dimethyl]siloxane-poly[propyl(phenyl)]siloxane copolymers, poly[dimethyl]siloxane-poly[butyl(phenyl)]siloxane copolymers, poly[methyl(phenyl)]siloxane-poly[pentyl(phenyl)]siloxane copolymers, poly[methyl(phenyl)]siloxane-poly[vinyl(phenyl)]siloxane copolymers, poly[methyl(phenyl)]siloxane-poly[allenyl(phenyl)]siloxane copolymers, poly[methyl(hydroxy)]siloxane-poly[butenyl(phenyl)]siloxane copolymers, poly[methyl(hydroxy)]siloxane-poly[pentenyl(phenyl)]siloxane copolymers, poly[methyl(hydroxy)]siloxane-poly[diphenyl]siloxane copolymers, poly[dimethyl]siloxane-poly[methoxy(phenyl)]siloxane copolymers, poly[ethyl(hydroxy)]siloxane-poly[ethoxy(phenyl)]siloxane copolymers, poly[ethyl(hydroxy)]siloxane-poly[propoxy(phenyl)]siloxane copolymers, poly[diethyl]siloxane-poly[isopropoxy(phenyl)]siloxane copolymers, poly[ethyl(methoxy)]siloxane-poly[hydroxy(phenyl)]siloxane copolymers, poly[dimethoxy]siloxane-poly[diphenyl]siloxane copolymers, and homologues and combinations thereof.

10. The polycarbonate resin composition of claim 1, wherein the phenyl-substituted siloxane copolymer comprises about 1 to about 18 parts by weight with reference to 100 parts by weight of the polycarbonate resin composition.

11. The polycarbonate resin composition of claim 1, wherein the phenyl-substituted siloxane copolymer comprises about 5 to about 15 parts by weight with reference to 100 parts by weight of the polycarbonate resin composition.

12. The polycarbonate resin composition according to claim 1, further comprising one or more additives selected from the group consisting of UV stabilizers, fluorescent brighteners, antioxidants, heat stabilizers, lubricants, release agents, nucleating agents, antistatic agents, stabilizers, reinforcing agents, inorganic additives, pigments, and dyes.

13. The polycarbonate resin composition of claim 1, wherein the composition is in the form of a molded article.

14. The polycarbonate resin composition of claim 13, wherein the molded article comprises at least part of an electronic product.

15. The polycarbonate resin composition of claim 13, wherein at least a portion of the composition has an average light reflectivity after UV irradiation for 24 hours of at least about 89.

16. The polycarbonate resin composition of claim 13, wherein at least a portion of the composition has a yellow index after UV irradiation for 24 hours of less than about 8.

17. The polycarbonate resin composition of claim 13, wherein at least a portion of the composition has an IZOD impact strength of at least about 65 when evaluated using ⅛″ specimens in accordance with ASTM D256.

18. A method of making a shaped polycarbonate resin composition, the method comprising:
providing a mass of the composition of claim 1; and
molding the mass into a molded article.

19. The method of claim 18, wherein the phenyl-substituted siloxane copolymer comprises 5-15 parts by weight with reference to 100 parts by weight of the polycarbonate resin.

20. The method of claim 18, wherein the molded article comprises at least a portion of an electronic product.
